(19) United States
(12) Patent Application Publication
(10) Pub. No.: US 2009/0310697 A1
(43) Pub. Date: Dec. 17, 2009

(54) MULTIPLE-INPUT MULTIPLE-OUTPUT (MIMO) TRANSMITTER AND COMMUNICATION SYSTEM

(76) Inventors: Qian YU, Singapore (SG); Lei HUANG, Singapore (SG); Liping SUN, Singapore (SG); Rong Hong MO, Singapore (SG)

Correspondence Address: WENDEROTH, LIND & PONACK L.L.P., 1030 15th Street, N.W., Suite 400 East, Washington, DC, 20005-1503, US

(21) Appl. No.: 12/481,881

(22) Filed: Jun. 10, 2009

(30) Foreign Application Priority Data
Jun. 13, 2008 (SG) 200804535-3

(51) Int. Cl. H04B 7/02; H04L 27/00

(52) U.S. Cl. 375/267; 375/295

(57) ABSTRACT

A Multiple-Input Multiple-Output (MIMO) transmitter 102 (104) comprises k transmit antennas 112₁, 112₂, . . . , 112ₖ (122₁, 122₂, . . . , 122ₖ) and an antenna hopping module 116 (126). The antenna hopping module 116 (126) processes an antenna hopping process for mapping the data streams s₁, , s₂, . . . , sₖ to the transmit antennas 112₁, 112₂, . . . , 112ₖ (122₁, 122₂, . . . , 122ₖ) based on a spatial correlation of the data streams s₁, s₂, . . . , sₖ in the respective transmit antennas 112₁, 112₂, . . . , 112ₖ (122₁, 122₂, . . . , 122ₖ).

### BACKGROUND OF THE INVENTION

1. Field of the Invention

The present invention relates broadly to a Multiple-Input Multiple-Output (MIMO) transmitter for transmitting a plurality of data streams in a Single Frequency Network (SFN) to a receiver, to a method for transmitting a plurality of data streams in a Single Frequency Network (SFN) to a receiver, and to a Multiple-Input Multiple-Output (MIMO) communication system for transmitting a plurality of data streams in a Single Frequency Network (SFN) to a receiver.

2. Description of the Related Art

A communication system is typically desired to provide reliable data transmission for a variety of applications, including voice and data applications. In a point-to-multipoint communications context, communication systems are typically based on multiple access communication schemes such as Frequency Division Multiple Access (FDMA), Time Division Multiple Access (TDMA), Code Division Multiple Access (CDMA), Orthogonal Frequency Division Multiple Access (OFDMA), and others.

In current times, manufactures are adding performance-enhancing features to wireless User Equipments (UEs) for use with cellular radio networks. With enhanced capabilities of their UEs, users are typically more interested in being able to receive television broadcasts. Since cellular infrastructure for transmitting to their UEs is already available, operators of cellular networks can benefit from providing broadcast or multicast services to their subscribers. Thus, live television, movies, sport clips, talk shows etc. can be broadcast or multicast from a cellular radio network, in addition to more conventional services provided by such networks. In effect, this is akin to providing cable or satellite channels directly to the UEs.

Multimedia Broadcast and Multicast Services (MBMS) can currently be offered via Global System for Mobile Communications (GSM) and Universal Mobile Telecommunications System (UMTS) cellular networks. Multimedia broadcast services can also be provided via dedicated broadcasting networks, e.g., a Digital Video Broadcasting (DVB) system. Enhanced versions for these broadcasting systems are currently being standardized in various standardization groups.

Downlink capacity is a typical performance characteristic of cellular systems. Increased downlink capacity can be used, for example, to make more broadcast and multicast channels available to the subscribers and to improve the quality of the broadcast and multicast transmissions. For a fixed frequency range available for cellular system transmissions, capacity depends typically on spectral efficiency. Given limited availability of electromagnetic spectrum, it is therefore desirable to increase spectral efficiency of cellular systems, including spectral efficiency of broadcasts and multicasts. In this regard, to avoid costs associated with infrastructure updating, it is also desirable to increase spectral efficiency of existing infrastructure without any changes or with limited changes.

Typical Multiple-Input Multiple-Output (MIMO) techniques have been considered for broadcasting and multicasting transmission in a number of standardization groups. The MIMO techniques can be used in a Single Frequency Network (SFN). The SFN is a radio network that typically operates a plurality of transmitters on the same frequency. To avoid or reduce interference, the transmitters are typically synchronized. Thus, a same signal is sent from the transmitters. Given a same transmit power budget, MIMO technology can enable increases in spectral efficiency of wireless communications. MIMO typically uses multiple spatially -diverse transmit antennas at transmitters, and multiple spatially -diverse receive antennas at receivers.

For MIMO communication systems operating in a SFN, Base Stations (BSs) of cellular radio network sites and User Equipments (UEs) comprise multiple antennas. In a bid to increase system capacity by increasing spectral efficiency, spatial multiplexing is typically applied to such MIMO broadcasting and multicasting systems. However, due to the existence of spatial correlation between the transmit antennas in each BS, a loss of system capacity cannot be avoided with conventional spatial multiplexing.

An example of a typical MIMO system in a SFN is provided below for illustration. Two BSs, BS1 and BS2, are provided for transmission to a UE. There are multiple transmit antennas at each BS and multiple receive antennas at the UE. Two physical transmission channels are present: one is a physical transmission channel between the BS1 and the UE and the other is a physical transmission channel between the BS2 and the UE. Each of these channels is subjected to channel conditions, such as delay, interference, noise, multipath fading, dispersion and distortion. Due to the spatial diversity of receive and transmit antennas, the combined effects of these channel conditions are typically different for each of these channels.

In this example, open loop MIMO technique or spatial multiplexing is used for increasing spectral efficiency of the cellular SFN broadcasting and multicasting. Since MIMO uses multiple transmit antennas, one way to employ MIMO is to transmit multiple streams from multiple transmit antennas of a same BS in a cell. In SFN deployment for broadcasting, a receive Signal-to-Noise Ratio (SNR) at a UE can be high. For example, for a macro-cell link budget with a 2800 meter inter-site distance, the SNR is typically higher than 14 dB for about 95% of users. Since multiple transmit and receive antennas are typically present, such a high SNR makes it feasible to use open loop (i.e. without feedback) MIMO as an additional option for Multimedia Broadcast and Multicast Services (MBMS).

By applying spatial multiplexing to the example system, four streams s₁, s₂, s₃ and s₄ are simultaneously transmitted respectively from four transmit antennas in the BS1 and four transmit antennas in the BS2. Therefore, received streams in the UE can be represented as

r=H₁A₁s+H₂A₂s+w=(H₁A₁+H₂A₂)s+w (1)

where r=[r₁ r₂ r₃ r₄]^{T} is a matrix of streams received by four receive antennas at the UE, s=[s₁ s₂ s₃ s₄]^{T} is a matrix of data streams transmitted from four transmit antennas in each BS, H₁ and H₂ are channel matrices between the BS1 and the UE, and the BS2 and the UE respectively, and w is a matrix of noise affecting the transmitted data streams. Matrices A₁ and A₂ are square roots of spatial correlation matrices of the BS1 and BS2 respectively.

For further illustrating the above implementation, US Pat. Pub. NO. 2007/0165566 describes a MIMO spatial multiplexing scheme which transmits same contents over same transmit antennas in different BSs in a SFN. The data streams are transmitted over transmit antennas in an identical order, i.e., data streams s₁, s₂, s₃ and s₄ are transmitted over transmit antennas Ant1, Ant2, Ant3 and Ant4 respectively in each of the BS1 and BS2. It will be appreciated that different data streams may exhibit different levels of robustness due to different transmit powers or different modulation and coding schemes.

The so-called Ergodic Capacity of a MIMO channel in the example system is given by

$$\begin{matrix}C = {E}_{{H}_{c}} [ log \vert I + SNR * {H}_{c} {H}_{c}^{H} \vert ] \\ where & ( 2 ) \\ {H}_{c} = {H}_{1} {A}_{1} + {H}_{2} {A}_{2} & ( 3 )\end{matrix}$$

I is an identity matrix and SNR is average SNRs of all data streams.

In broadcast and multicast transmission, feedback is typically not feasible and thus, link adaptation cannot be implemented due to the absence of feedback. In such cases, average SNRs of all data streams can be optimized to achieve high capacity. However, due to the existence of spatial correlation between the transmit antennas in each BS, keeping the same mapping order in all BSs typically causes the average SNRs to vary for different data streams due to various spatial correlation factors, e.g., some data streams are always higher in SNRs than other data streams. Therefore, capacity loss typically occurs in such MIMO systems, especially with high spatial correlation. That is, system capacity typically decreases with the increasing of spatial correlation between the transmit antennas for increasing spectral efficiency.

### SUMMARY OF THE INVENTION

In view of the above problem, the present invention provides a Multiple-Input Multiple-output (MIMO) transmitter for transmitting a plurality of data streams in a Single Frequency Network (SFN) to a receiver, a method for transmitting a plurality of data streams in a Single Frequency Network (SFN) to a receiver, and a Multiple-Input Multiple-output (MIMO) communication system for transmitting a plurality of data streams in a Single Frequency Network (SFN) to a receiver that are capable of improving system capacity.

In accordance with one aspect of the present invention, there is provided a Multiple-Input Multiple-Output (MIMO) for a Multiple-Input Multiple-Output (MIMO) transmitter for transmitting a plurality of data streams in a Single Frequency Network (SFN) to a receiver, the MIMO transmitter comprising: a plurality of transmit antennas; and an antenna hopping module for performing an antenna hopping that maps the data streams to the respective transmit antennas based on a spatial correlation of the data streams in the respective transmit antennas.

According to this MIMO transmitter, the data streams are mapped to the respective transmit antennas based on the spatial correlation of the data streams in the respective transmit antennas. Therefore, the MIMO transmitter is capable of improving system capacity.

The antenna hopping may be performed using a permutation matrix formed based on the spatial correlation of the data streams in the respective transmit antennas.

The antenna hopping module may perform the antenna hopping such that Signal-to-Noise Ratios of the data streams at the receiver are balanced as a result of permutations of the data streams in respective MIMO transmitters of the SFN.

With the stated structure, high system capacity can be achieved.

The Signal-to-Noise Ratios of the data streams may be balanced to approach identical values.

The antenna hopping module may perform the antenna hopping that maps the data streams in a varying antenna mapping pattern for different transmission time slots.

With the stated structure, since the same data stream is transmitted from different transmit antennas for different transmission time slots, spatial diversity can be improved.

The MIMO transmitter may further comprise a power allocation module for performing a power allocation that adjusts power allocation to the data streams.

With the stated structure, system capacity can further be improved.

The power allocation may be performed using a power allocation matrix.

The data streams and corresponding data streams being transmitted by other MIMO transmitters in the SFN may comprise same data contents.

The number of transmit antennas may be more than three.

The MIMO transmitter may be a Base Station.

In accordance with another aspect of the present invention, there is provided a method for transmitting a plurality of data streams in a Single Frequency Network (SFN) to a receiver, the method comprising: mapping the data streams to respective transmit antennas of a Multiple-Input Multiple-Output (MIMO) transmitter based on a spatial correlation of the data streams in the respective transmit antennas.

According to this method, the data streams are mapped to the respective transmit antennas based on the spatial correlation of the data streams in the respective transmit antennas. Therefore, the method is capable of improving system capacity.

Where a plurality of Multiple-Input Multiple-Output (MIMO) transmitters is used, the method may comprise: grouping the MIMO transmitters into different groups; assigning a set of antenna mapping patterns to each group; wherein within each group, assigning each MIMO transmitter with a different antenna mapping pattern from the set; mapping the data streams to respective transmit antennas of each MIMO transmitter using its respective assigned antenna mapping pattern; and wherein the antenna mapping pattern is based on a spatial correlation of the data streams in the respective transmit antennas.

According to this method, in case that the number of MIMO transmitters is larger than the number of transmit antennas of the MIMO transmitters, improvement of system capacity can be achieved effectively.

Said grouping the MIMO transmitters into different groups may comprise grouping the MIMO transmitters in groups of four into N groups and grouping the remainder of the MIMO transmitters into a (N+1)th group; the method further comprising: for each N group, assigning a first antenna mapping pattern to a first MIMO transmitter; assigning a second antenna mapping pattern to a second MIMO transmitter; assigning a third antenna mapping pattern to a third MIMO transmitter; assigning a fourth antenna mapping pattern to a fourth MIMO transmitter; for (N+1)th group, if the number of MIMO transmitters is one in the (N+1)th group, assigning one of the first, second third and fourth antenna mapping patterns to that one MIMO transmitter; if the number of MIMO transmitters is two in the (N+1)th group, assigning different antenna mapping patterns to the MIMO transmitters by selecting one set from a set comprising the first and third antenna mapping patterns and a set comprising the second and fourth antenna mapping patterns; if the number of MIMO transmitters is three in the (N+1)th group, assigning different antenna mapping patterns to the MIMO transmitters by selecting one set from a set comprising the first, second and third antenna mapping patterns, a set comprising the first, third and fourth antenna mapping patterns, a set comprising the first, second and fourth antenna mapping patterns and a set comprising the second, third and fourth antenna mapping patterns.

In accordance with yet another aspect of the present invention, there is provided a Multiple-Output Multiple-Input (MIMO) communication system for transmitting a plurality of data streams in a Single Frequency Network (SFN) to a receiver, the MIMO communication system comprising: two or more MIMO transmitters, each MIMO transmitter for transmitting the plurality of data streams; wherein each MIMO transmitter comprising: a plurality of transmit antennas, and an antenna hopping module for antenna hopping that maps the data streams to the respective transmit antennas based on a spatial correlation of the data streams in the respective transmit antennas.

According to this MIMO communication system, at each MIMO transmitter, the data streams are mapped to the respective transmit antennas based on the spatial correlation of the data streams in the respective transmit antennas. Therefore, the MIMO communication system is capable of improving system capacity.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 is a schematic diagram illustrating antenna hopping of two Base Stations (BSs) in a cellular Single Frequency Network (SFN) system in the first embodiment.

FIG. 2 is a schematic flowchart illustrating a process for performing distributed antenna hopping in each Base Station (BS) shown in FIG. 1.

FIG. 3 is a schematic diagram illustrating antenna hopping of two Base Stations (BSs) in a cellular Single Frequency Network (SFN) system in the second embodiment.

FIG. 4 is a schematic diagram illustrating antenna hopping of four Base Stations (BSs) in a cellular Single Frequency Network (SFN) system in the third embodiment.

FIG. 5 is a schematic diagram illustrating antenna hopping and power allocation of two Base Stations (BSs) in a cellular Single Frequency Network (SFN) system in the fifth embodiment.

FIG. 6 is a graph of Ergodic capacity against Signal-to-Ratio (SNR) based on simulation results.

FIG. 7 is a schematic flowchart for illustrating a method for transmitting a plurality of data streams in a Single Frequency Network (SFN) to a User Equipment (UE) using a plurality of Multiple-Input Multiple-Output (MIMO) transmitters in the sixth embodiment.

FIG. 8 is a schematic flowchart for illustrating a method for antenna hopping pattern selection in the seventh embodiment.

### DESCRIPTION OF THE PREFERRED EMBODIMENTS

The embodiments described herein can improve spectral efficiency and can compensate capacity loss. The embodiments can apply distributed antenna hopping in multi-cell Single Frequency Network (SFN) transmissions by changing the antenna mapping pattern between data streams and transmit antennas in each BS or in each BS within each group to balance average SNRs of all data streams such that the average SNRs approach an identical value.

In the embodiments described below, a Multiple-Input Multiple-Output (MIMO) transmitter and a receiver are described to be a Base station (BS) and a User Equipment (UE) respectively. However, it will be appreciated by a person skilled in the art that the embodiments are not limited to cases where the MIMO transmitter and the receiver are the BS and the UE.

In the embodiments described below, the number of transmit antennas for each Base Station (BS) is described to be more than three. However, it will be appreciated by a person skilled in the art that the embodiments are not limited to cases where each BS comprises more than three transmit antennas. That is, the embodiments can also work for cases where each BS comprises more than two transmit antennas.

For description purposes only, an even number of transmit antennas, e.g. four transmit antennas, have been described in the following embodiments. It will be appreciated that, generally, industry/technology standardizations do not consider an odd number of transmit antennas in Multiple-Input Multiple-Output (MIMO) systems. Further, an optimum balance of e.g. Signal-to-Noise Ratios (SNRs) can be more difficult to attain for an odd number of transmit antennas. However, it will also be appreciated by a person skilled in the art that the embodiments are not limited to working with an even number of transmit antennas and can also apply for Base Stations (BSs) comprising an odd number of transmit antennas, e.g. three transmit antennas.

The following describes the embodiments of the present invention, with reference to the drawings.

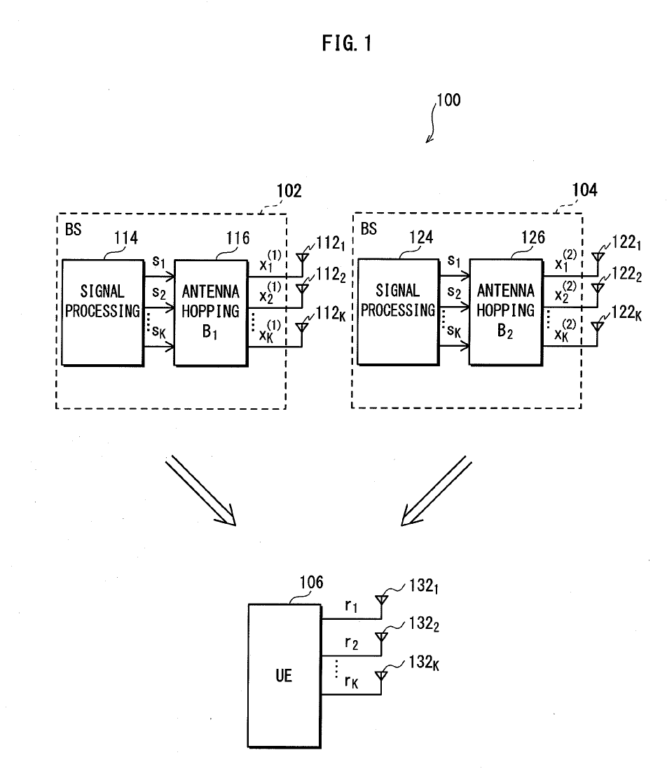

FIG. 1 is a schematic diagram illustrating antenna hopping of two Base Stations (BSs) in a cellular Single Frequency Network (SFN) system 100 in the first embodiment. There are provided two cells. Each cell comprises a BS. Each BS comprises more than three transmit antennas.

In the first embodiment, a BS 102 provided in the SFN system 100 comprises k transmit antennas 112₁, 112₂, . . . , 112ₖ, a signal processing module 114, and an antenna hopping module 116. A BS 104 provided in the SFN system 100 comprises K transmit antennas 122₁, 122₂, . . . , 122ₖ, a signal processing module 124 and an antenna hopping module 126. A User Equipment (UE) 106 provided in the SFN system 100 comprises k receive antennas 132₁, 132₂, . . . , 132ₖ.

The signal processing modules 114, 124 receive a number of input signals (not shown in FIG. 1) and process the received input signals into data streams s₁, s₂, . . . , sₖ. The processing may include channel coding, modulation and/or other techniques. The antenna hopping modules 116, 126 perform antenna hopping that maps the data streams to the respective transmit antennas based on a spatial correlation in the respective transmit antennas. The data streams s₁, s₂, . . . , sₖ are then transmitted by the transmit antennas 112₁, 112₂, . . . , 112ₖ and the transmit antennas 122₁, 122₂, . . . , 122ₖ. The antenna hopping is realized by applying different antenna mapping patterns between physical antennas and data streams which are intended for broadcast or multicast to User Equipments (UEs) in each cell.

In the first embodiment, the antenna hopping module 116 multiplies a permutation matrix B₁ with a data stream matrix s=[s₁ s₂ . . . sₖ]^{T} to obtain a matrix x⁽¹⁾=[x₁⁽¹⁾ x₂⁽¹⁾ . . . xₖ⁽¹⁾]^{T} and maps the permutated data streams x₁⁽¹⁾, x₂⁽¹⁾, . . . , xₖ⁽¹⁾ to the transmit antennas 112₁, 112₂, . . . , 112ₖ respectively. The antenna hopping module 126 multiplies a permutation matrix B₂ with the data stream matrix s=[s₁ s₂ . . . sₖ]^{T} to obtain a matrix x⁽²⁾=[x₁⁽²⁾ x₂⁽²⁾ . . . xₖ⁽²⁾]^{T} and maps the permutated data streams x₁⁽²⁾, x₂⁽²⁾, . . . , xₖ⁽²⁾ to the transmit antennas 122₁, 122₂, . . . , 122ₖ respectively. In the first embodiment, each permutation matrix B₁, B₂ is a matrix obtained by column permutation and/or row permutation of an identity matrix with a dimension of the number of data streams. The column permutation and/or row permutation of the identity matrix is performed to differ between the BSs 102, 104 based on a spatial correlation of the data streams in the respective transmit antennas.

After applying the antenna hopping, the permutated data streams are transmitted to the UE 106 from the transmit antennas 112₁, 112₂, . . . , 112ₖ respectively in the BS 102 and simultaneously, the permutated data streams are transmitted to the UE 106 from the transmit antennas 122₁, 122₂, . . . , 122ₖ respectively in the BS 104. Streams r=[r₁ r₂ . . . rₖ]^{T} received by the receive antennas 132₁, 132₂, . . . , 132ₖ at the UE 106 are represented as

r=H₁A₁x⁽¹⁾+H₂A₂x⁽²⁾+w=(H₁A₁B₁+H₂A₂B₂)s+w (4)

In contrast to the system illustrated with equation (1), in the first embodiment, same contents with different mapping orders are transmitted from each BS 102, 104 using a distributed antenna hopping method. Thus, by varying data stream mapping to physical antennas at the BSs based on spatial correlation, the channel spatial correlation experienced by each data stream can be balanced. Therefore, in the first embodiment, average Signal-to-Noise Ratios (SNRs) of all data streams can be balanced to approach identical values to achieve higher capacity.

In the first embodiment, the Ergodic Capacity of a MIMO channel in the SFN system 100 is given by

$$\begin{matrix}C = {E}_{{H}_{c}} [ log \vert I + SNR * {\overline{H}}_{c} {\overline{H}}_{c}^{H} \vert ] \\ where & ( 5 ) \\ {\overline{H}}_{c} = {H}_{1} {A}_{1} {B}_{1} + {H}_{2} {A}_{2} {B}_{2} & ( 6 )\end{matrix}$$

At the UE side, the combined channel H̅_{c} can be estimated based on pilot signals and linear MIMO detection can be implemented with using the estimated combined channel H̅_{c}.

It is preferred that the permutation matrices B₁, B₂ are designed such that spatial correlations experienced by each data stream among the two BSs 102, 104 are balanced, in other words, such that SNRs of the data streams at the UE 106 are balanced to approach identical values as a result of permutations of the data streams in respective BSs 102, 104.

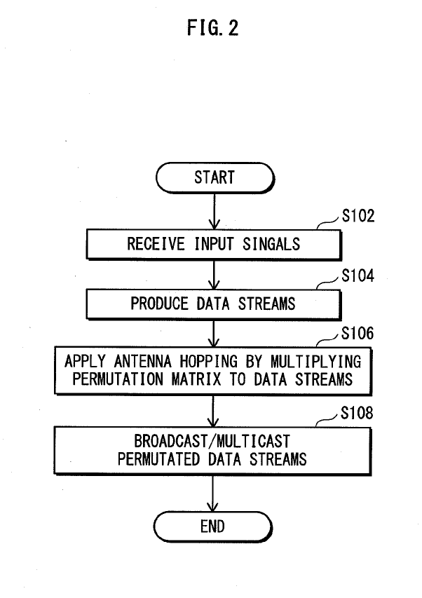

FIG. 2 is a schematic flowchart illustrating a process for performing distributed antenna hopping in each Base Station (BS) 102, 104 shown in FIG. 1.

At step S102, operation begins with receiving a number of input signals at the BS 102 (104). At step S104, the received input signals are processed to be the data streams intended for broadcast or multicast to UEs by the signal processing module 114 (124). At step S106, the produced data streams are then applied with the antenna hopping by being multiplied with the permutation matrix B₁, (B₂) by the antenna hopping module 116 (126) at the BS 102 (104). At step S108, the permutated data streams are broadcast or multicast from the transmit antennas 112₁, 112₂, . . . , 112ₖ (122₁, 122₂, . . . , 122ₖ) at the BS 102 (104).

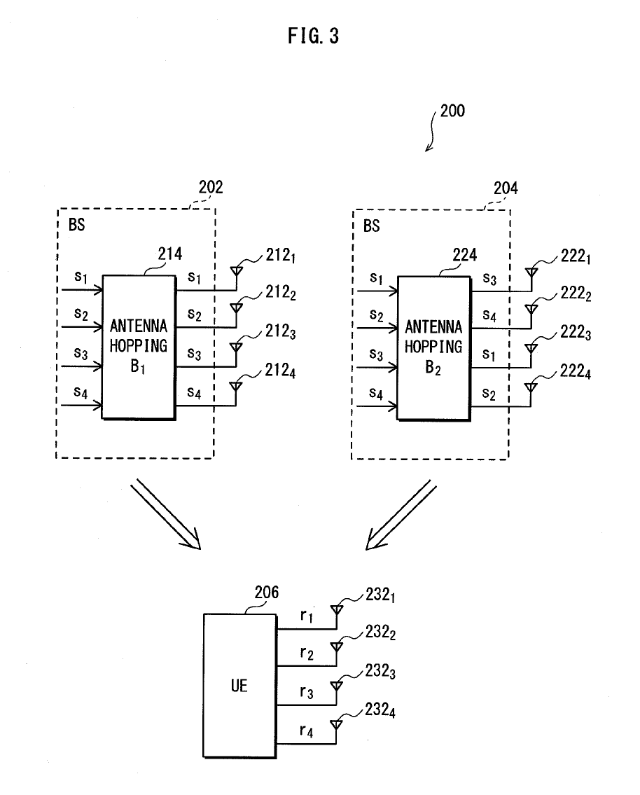

FIG. 3 is a schematic diagram illustrating antenna hopping of two Base Stations (BSs) in a cellular Single Frequency Network (SFN) system 200 in the second embodiment. The following describes the antenna hopping in detail.

In the SFN system 200, there are provided two Base Stations (BSs) 202, 204 and a User Equipment (UE) 206. The BS 202 comprises four transmit antennas 212₁, 212₂, 212₃, 212₄ and an antenna hopping module 214. The BS 204 comprises four transmit antennas 222₁, 222₂, 222₃, 222₄ and an antenna hopping module 224. The UE 206 comprises four receive antennas 232₁, 232₂, 232₃, 232₄. The BS 202 and BS 204 transmit data streams to the UE 206 using distributed antenna hopping. In the second embodiment, with spatial multiplexing, four data streams s₁, s₂, s₃, s₄ are broadcast or multicast to the UE 206.

It is assumed that the transmit antennas are correlated to each other and the spatial correlations are the same in all BSs 202, 204. For example, the respective transmitter correlation matrices are A₁=A₂=A. Further, it is assumed that the transmit antennas are set up linearly. Thus, the spatial correlation matrix can be expressed as

$$A = [ \begin{matrix}1 & {ρ}_{12} & {ρ}_{13} & {ρ}_{14} \\ {ρ}_{12} & 1 & {ρ}_{23} & {ρ}_{24} \\ {ρ}_{13} & {ρ}_{23} & 1 & {ρ}_{34} \\ {ρ}_{14} & {ρ}_{24} & {ρ}_{34} & 1\end{matrix} ] \qquad ( 7 )$$

Therefore, from equation (7), the spatial correlation experienced by a data stream transmitted from the transmit antennas 212₁, 222₁ depends on ρ₁₂, ρ₁₃ and ρ₁₄, and the spatial correlation experienced by a data stream transmitted from the transmit antennas 212₂, 222₂ depends on ρ₁₂, ρ₂₃ and ρ₂₄. It will be appreciated that ρ₂₃>ρ₁₃ and ρ₂₄>ρ₁₄. Therefore, the spatial correlation experienced by the data stream transmitted from the transmit antennas 212₂, 222₂ is larger than the spatial correlation experienced by the data stream transmitted from the transmit antennas 212₁, 222₁. Similarly, the spatial correlation experienced by a data stream transmitted from the transmit antennas 212₃, 222₃ is larger than the spatial correlation experienced by a data stream transmitted from the transmit antennas 212₄, 222₄.

In order to balance the spatial correlation experienced by each data stream among the two BSs 202, 204, in the second embodiment, distributed antenna hopping is implemented by applying respective permutation matrices B₁, B₂ to adjust antenna mapping patterns between the data streams and the transmit antennas based on the spatial correlation matrix of equation (7). For example, let

$${B}_{1} = [ \begin{matrix}1 & 0 & 0 & 0 \\ 0 & 1 & 0 & 0 \\ 0 & 0 & 1 & 0 \\ 0 & 0 & 0 & 1\end{matrix} ] and {B}_{2} = [ \begin{matrix}0 & 0 & 1 & 0 \\ 0 & 0 & 0 & 1 \\ 1 & 0 & 0 & 0 \\ 0 & 1 & 0 & 0\end{matrix} ] \qquad ( 8 )$$

The antenna hopping module 214 multiplies the permutation matrix B₁ with a data stream matrix s=[s₁ s₂ s₃ s₄]^{T} to obtain a matrix x⁽¹⁾=[s₁ s₂ s₃ s₄]^{T} and maps the permutated data streams s₁, s₂, s₃, s₄ to the transmit antennas 212₁, 212₂, 212₃, 212₄ respectively. The antenna hopping module 224 multiplies the permutation matrix B₂ with the data stream matrix s=[s₁ s₂ s₃ s₄]^{T} to obtain a matrix x⁽²⁾=[s₃ s₄ s₁ s₂]^{T} and maps the permutated data streams s₃, s₄, s₁, s₂ to the transmit antennas 222₁, 222₂, 222₃, 222₄ respectively.

Therefore, the permutated data streams s₁, s₂, s₃, s₄ are transmitted from the transmit antennas 212₁, 212₂, 212₃, 212₄ respectively in the BS 202 and simultaneously, the permutated data streams s₃, s₄, s₁, s₂ are transmitted from the transmit antennas 222₁, 222₂, 222₃, 222₄ respectively in the BS 204. Thus, the same data streams s₁, s₂, s₃, s₄ are transmitted to the UE 206 with different mapping orders in the different BS 202, 204 to balance the spatial correlations experienced by each data stream.

Therefore, in the second embodiment, a plurality of antenna mapping patterns can be designed and distributed to the BSs to balance average transmit spatial correlation experienced by each of the data streams.

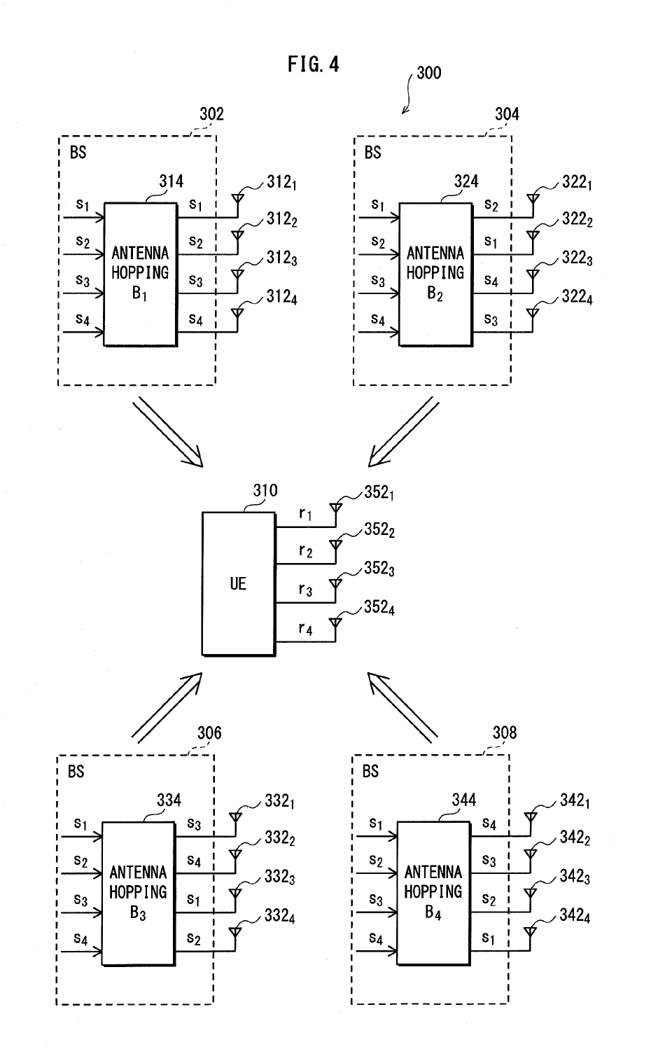

FIG. 4 is a schematic diagram illustrating antenna hopping of four Base Stations (BSs) in a cellular Signal Frequency Network (SFN) system 300 in the third embodiment. The following describes the distributed antenna hopping in detail.

In the SFN system 300, there are provided four Base stations (BSs) 302, 304, 306, 308 and a User Equipment (UE) 310. The BS 302 comprises four transmit antennas 312₁, 312₂, 312₃, 312₄ and an antenna hopping module 314. The BS 304 comprises four transmit antennas 322₁, 322₂, 322₃, 322₄ and an antenna hopping module 324. The BS 306 comprises four transmit antennas 332₁, 332₂, 332₃, 332₄ and an antenna hopping module 334. The BS 308 comprises four transmit antennas 342₁, 342₂, 342₃, 342₄ and an antenna hopping module 344. The UE 310 comprises four receive antennas 352₁, 352₂, 352₃, 352₄. The BS 302, BS 304, BS 306 and BS 308 transmit data streams to the UE 310 using distributed antenna hopping. In the third embodiment, using spatial multiplexing, four data streams s₁, s₂, s₃, s₄ are broadcast or multicast to the UE 310.

In order to balance the spatial correlation experienced by each data stream among four BSs 302, 304, 306, 308, in the third embodiment, each stream is mapped to a different one of four transmit antennas in each BSs 302, 304, 306, 308. For example, the same data stream s₁ is mapped to the transmit antenna 312₁ in the BS 302, the transmit antenna 322₂ in the BS 304, the transmit antenna 332₃ in the BS 306, and the transmit antenna 342₄ in the BS 308. That is, distributed antenna hopping is implemented by applying respective permutation matrices B₁, B₂, B₃, B₄ to adjust antenna mapping patterns between the data streams and the physical antennas based on the spatial correlation matrix of equation (7). For example, let

$${B}_{1} = [ \begin{matrix}1 & 0 & 0 & 0 \\ 0 & 1 & 0 & 0 \\ 0 & 0 & 1 & 0 \\ 0 & 0 & 0 & 1\end{matrix} ] , \\ {B}_{2} = [ \begin{matrix}0 & 1 & 0 & 0 \\ 1 & 0 & 0 & 0 \\ 0 & 0 & 0 & 1 \\ 0 & 0 & 1 & 0\end{matrix} ] , \\ {B}_{3} = [ \begin{matrix}0 & 0 & 1 & 0 \\ 0 & 0 & 0 & 1 \\ 1 & 0 & 0 & 0 \\ 0 & 1 & 0 & 0\end{matrix} ] , \\ {B}_{2} = [ \begin{matrix}0 & 0 & 0 & 1 \\ 0 & 0 & 1 & 0 \\ 0 & 1 & 0 & 0 \\ 1 & 0 & 0 & 0\end{matrix} ] \qquad ( 9 )$$

The antenna hopping module 314 multiplies the permutation matrix B₁ with a data stream matrix s=[s₁ s₂ s₃ s₄]^{T} to obtain a matrix x⁽¹⁾=[s₁ s₂ s₃ s₄]^{T} and maps the permutated data streams s₁, s₂, s₃, s₄ to the transmit antennas 312₁, 312₂, 312₃, 312₄ respectively. The antenna hopping module 324 multiplies the permutation matrix B₂ with the data stream matrix s=[s₁ s₂ s₃ s₄]^{T} to obtain a matrix x⁽²⁾=[s₂ s₁ s₄ s₃]^{T} and maps the permutated data streams s₂, s₁, s₄, s₃ to the transmit antennas 322₁, 322₂, 322₃, 322₄ respectively. The antenna hopping module 334 multiplies the permutation matrix B₃ with the data stream matrix s=[s₁ s₂ s₃ s₄]^{T} to obtain a matrix x⁽³⁾=[s₃ s₄ s₁ s₂]^{T} and maps the permutated data streams s₃, s₄, s₁, s₂ to the transmit antennas 332₁, 332₂, 332₃, 332₄ respectively. The antenna hopping module 344 multiplies the permutation matrix B₄ with the data stream matrix s=[s₁ s₂ s₃ s₄]^{T} to obtain a matrix x⁽⁴⁾=[s₄ s₃ s₂ s₁]^{T} and maps the permutated data streams s₄, s₃, s₂, s₁ to the transmit antennas 342₁, 342₂, 342₃, 342₄ respectively.

Thus, the permutated data streams s₁, s₂, s₃, s₄ are transmitted from the four transmit antennas 312₁, 312₂, 312₃, 312₄ respectively in the BS 302, and simultaneously, the permutated data streams s₂, s₁, s₄, s₃ are transmitted from the four transmit antennas 322₁, 322₂, 322₃, 322₄ respectively in the BS 304, the permutated data streams s₃, s₄, s₁, s₂ are transmitted from the four transmit antennas 332₁, 332₂, 332₃, 332₄ respectively in the BS 306 and the permutated data streams s₄, s₃, s₂, s₁ are transmitted from the four transmit antennas 342₁, 342₂, 342₃, 342₄ respectively in the BS 308. Thus, the same data streams s₁, s₂, s₃, s₄ are transmitted to the UE 310 with different mapping orders in the different BS 302, 304, 306, 308 to balance the spatial correlations experienced by each data stream.

Table 1 below summaries the antenna mapping pattern design for antenna hopping among the four BSs 302, 304, 306, 308 in the third embodiment.

TABLE 1

| | BS 302 | BS 304 | BS 306 | BS 308 |
|---|---|---|---|---|
| Ant1 | S1 | S2 | S3 | S4 |
| Ant2 | S2 | S1 | S4 | S3 |
| Ant3 | S3 | S4 | S1 | S2 |
| Ant4 | S4 | S3 | S2 | S1 |

In Table 1, Ant1 corresponds to each of the transmit antennas 312₁, 322₁, 332₁, 342₁. Ant2 corresponds to each of the transmit antennas 312₂, 322₂, 332₂, 342₂. Ant3 corresponds to each of the transmission antennas 312₃, 322₃, 332₃, 342₃. Ant4 corresponds to each of the transmission antennas 312₄, 322₄, 332₄, 342₄.

In the fourth embodiment, antenna hopping can be implemented in time direction. That is, antenna mapping patterns between data streams and physical transmit antennas can further be changed in different transmission time slots.

In the fourth embodiment, each BS (BS1, BS2, BS3, BS4) comprises four transmit antennas (Ant1, Ant2, Ant3, Ant4) and an antenna hopping module and each UE comprises four receive antennas. Using spatial multiplexing, four data streams s₁, s₂, s₃, s₄ are broadcast or multicast to each UE.

Table 2 below is provided to show varying antenna mapping patterns in each of four BS1, BS2, BS3, BS4 in accordance with different transmission time slots t, t+T, t+2T, t+3T.

TABLE 2

| | BS1 | | | | BS2 | | | | BS3 | | | | BS4 | | | |
|---|---|---|---|---|---|---|---|---|---|---|---|---|---|---|---|---|
| | | Time | Time | Time | | Time | Time | Time | | Time | Time | Time | | Time | Time | Time |
| | Time t | t + T | t + 2T | t + 3T | Time t | t + T | t + 2T | t + 3T | Time t | t + T | t + 2T | t + 3T | Time t | t + T | t + 2T | t + 3T |
| Ant1 | s₁ | s₂ | s₃ | s₄ | s₂ | s₃ | s₄ | s₁ | s₃ | s₄ | s₁ | s₂ | s₄ | s₁ | s₂ | s₃ |
| Ant2 | s₂ | s₁ | s₄ | s₃ | s₁ | s₄ | s₃ | s₂ | s₄ | s₃ | s₂ | s₁ | s₃ | s₂ | s₁ | s₄ |
| Ant3 | s₃ | s₄ | s₁ | s₂ | s₄ | s₁ | s₂ | s₃ | s₁ | s₂ | s₃ | s₄ | s₂ | s₃ | s₄ | s₁ |
| Ant4 | s₄ | s₃ | s₂ | s₁ | s₃ | s₂ | s₁ | s₄ | s₂ | s₁ | s₄ | s₃ | s₁ | s₄ | s₃ | s₂ |
| | B₁ | B₂ | B₃ | B₄ | B₂ | B₃ | B₄ | B₁ | B₃ | B₄ | B₁ | B₂ | B₄ | B₁ | B₂ | B₃ |

Where B₁, B₂, B₃, B₄ are the permutation matrices shown in equation (9).

The antenna hopping module of the BS1 uses the permutation matrices B₁, B₂, B₃, B₄ in the time slots t+4n, t+(4n+1)T, t+(4n+2)T, t+(4n+3)T respectively for performing antenna hopping. The antenna hopping module of the BS2 uses the permutation matrices B₂, B₃, B₄, B₁ in the time slots t+4n, t+(4n+1)T, t+(4n+2)T, t+(4n+3)T respectively for performing antenna hopping. The antenna hopping module of the BS3 uses the permutation matrices B₃, B₄, B₁, B₂ in the time slots t+4n, t+(4n+1)T, t+(4n+2)T, t+(4n+3)T respectively for performing antenna hopping. The antenna hopping module of the BS4 uses the permutation matrix B₄, B₁, B₂, B₃ in the time slots t+4n, t+(4n+1)T, t+(4n+2)T, t+(4n+3)T respectively for performing antenna hopping. Where n=0, 1, 2, . . . .

It will be appreciated that although Table 2 illustrates four BSs each with four transmit antennas, the fourth embodiment is not limited as such and can be generalized to apply to systems with each BS having a different number of transmit antennas and a SFN having a different number of BSs.

In the fifth embodiment, applying antenna hopping with power allocation can further improve bandwidth efficiency.

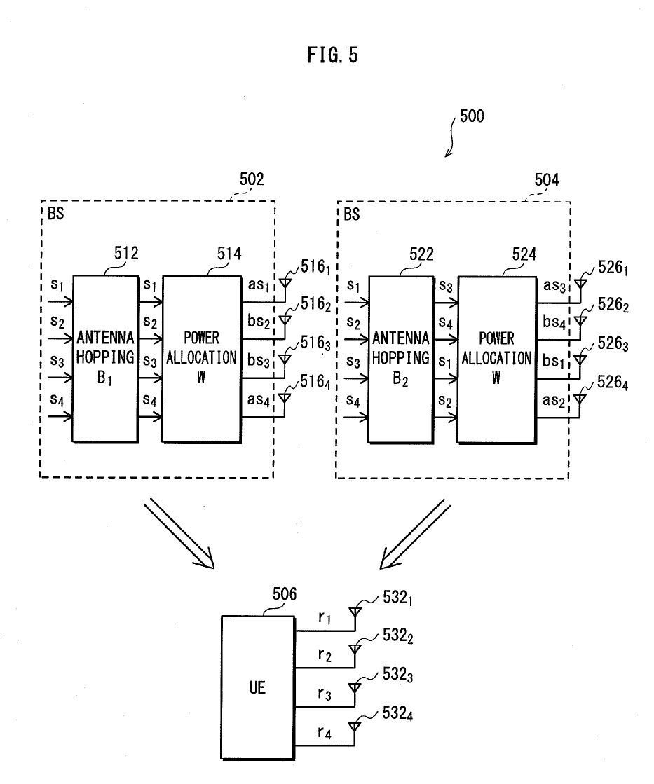

FIG. 5 is a schematic diagram illustrating antenna hopping and power allocation of two Base Stations (BSs) in a cellular Single Frequency Network (SFN) system 500 in the fifth embodiment. The following describes the antenna hopping and power allocation in detail.

In the SFN system 500, there are provided two Base Stations (BSs) 502, 504 and a User Equipment (UE) 506. The BS 502 comprises antenna hopping module 512, a power allocation module 514 and four transmit antennas 516₁, 516₂, 516₃, 516₄. The BS 504 comprises an antenna hopping module 522, a power allocation module 524 and four transmit antennas 526₁, 526₂, 526₃, 526₄. The UE 506 comprises four receive antennas 532₁, 532₂, 532₃, 532₄.

In the fifth embodiment, using spatial multiplexing, four data streams s₁, s₂, s₃, s₄ are broadcast or multicast to the UE 506. To balance the spatial correlation experienced by each data stream among the two BSs 502, 504, distributed antenna hopping is implemented at the antenna hopping modules 512, 522 by applying respective permutation matrices B₁, B₂ shown in equation (8) to adjust antenna mapping patterns between the data streams and physical antennas based on the spatial correlation matrix of equation (7). That is, the antenna hopping module 512 multiplies the permutation matrix B₁ with the data stream matrix s=[s₁ s₂ s₃ s₄]^{T} to obtain a matrix x⁽¹⁾=[s₁ s₂ s₃ s₄]^{T}. The antenna hopping module 522 multiplies the permutation matrix B₂ with the data stream matrix s=[s₁ s₂ s₃ s₄]^{T} to obtain a matrix x⁽²⁾=[s₃ s₄ s₁ s₂]^{T}.

After applying the antenna hopping, power allocation is applied to the permuted data streams. That is, the permuted data streams are multiplied with a power allocation matrix W at the respective power allocation modules 514, 524. It will be appreciated that the matrix provides power allocation weights. W is assumed as

$$W = [ \begin{matrix}a & 0 & 0 & 0 \\ 0 & b & 0 & 0 \\ 0 & 0 & b & 0 \\ 0 & 0 & 0 & a\end{matrix} ] \qquad ( 10 )$$

where a²+b²=2. In the fourth embodiment, the power allocation matrix W is a diagonal matrix maintaining the total transmission power as a constant. For example, these “a” and “b” are designed so that transmission power of data stream having low spatial correlation is larger than transmission power of data stream having high spatial correlation.

The power allocation module 514 multiplies the matrix W with the matrix x⁽¹⁾=[s₁ s₂ s₃ s₄]^{T} to obtain a matrix xₚ⁽¹⁾=[as₁ bs₂ bs₃ as₄]^{T}. The power allocation module 524 multiplies the matrix W with the matrix x⁽²⁾=[s₃ s₄ s₁ s₂]^{T} to obtain a matrix xₚ⁽²⁾=[as₃ bs₄ bs₁ as₂]^{T}.

Thus, the data streams as₁, bs₂, bs₃, as₄ are transmitted from the transmit antennas 516₁, 516₂, 516₃, 516₄ respectively in the BS 502, and simultaneously, the data streams as₃, bs₄, bs₁, as₂ are transmitted from the transmit antennas 526₁, 526₂, 526₃, 526₄ respectively in the BS 504. Thus, the same data streams s₁, s₂, s₃, s₄ are transmitted to the UE 506 with different mapping orders in each different BS to balance the spatial correlations experienced by each data stream. It will be appreciated that the benefit of antenna hopping is even more significant in a case where power distribution is different over each transmit antenna.

In the fifth embodiment, the Ergodic Capacity of MIMO channel in the SFN system 500 is given by

$$\begin{matrix}C = {E}_{{H}_{c}} [ log \vert I + SNR * {\overline{H}}_{c} {\overline{H}}_{c}^{H} \vert ] \\ where & ( 11 ) \\ {\overline{H}}_{c} = {H}_{1} {A}_{1} {WB}_{1} + {H}_{2} {A}_{2} {WB}_{2} & ( 12 )\end{matrix}$$

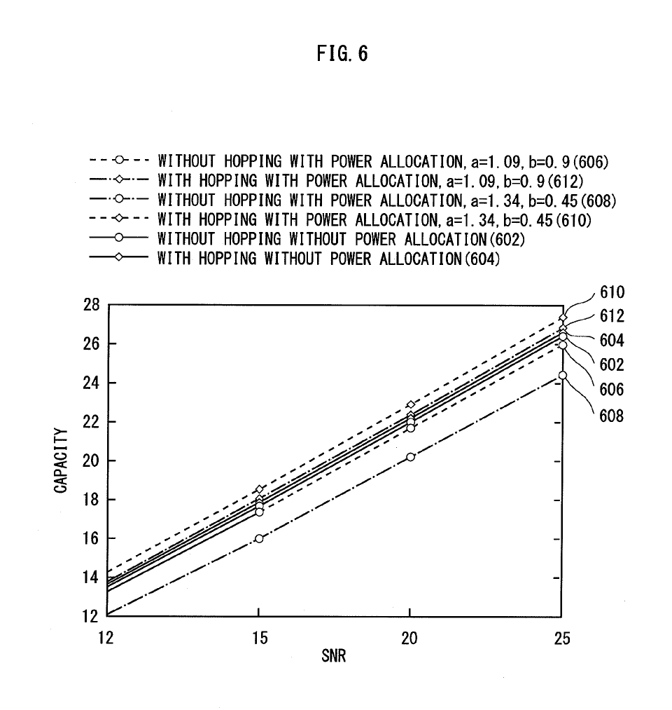

FIG. 6 is a graph of Ergodic capacity against SNR based on simulation results. In the simulations, it is assumed that the spatial correlations between transmit antennas are the same in different BSs, that is A₁=A₂=A (compare equation (7)). In the simulations, Ergodic capacity is calculated using equations (11) and (12) for different spatial correlation values. Comparisons are made between pure spatial multiplexing of the prior art (compare 602) and spatial multiplexing with distributed antenna hopping without power allocation (compare 604). Also, comparisons are made between cases with power allocation (e.g. compare 610) and cases without power allocation (e.g. compare 604).

An assumption taken for the simulations is that there are four transmit antennas in each of two Base Stations (BSs) and four receive antennas in a User Equipment (UE). Referring to FIG. 6, without antenna hopping, although equal power among transmit antennas can achieve best capacity in theory, the power allocation causes capacity degradation (see 602, 606, 608). By comparing a case without antenna hopping versus a case using antenna hopping, it can be observed that capacity improvement is achieved with equal power allocation, i.e. no using of power allocation weights (compare 602 vs. 604). It is also noted that significant capacity gains are obtained with a combination of power allocation over transmit antennas (i.e. compare 610 vs. 604 or compare 612 vs. 604). Thus, it has been shown that spatial multiplexing with antenna hopping of the embodiments can increase system capacity. Preferably, it has been shown in the embodiments that combine power allocation with antenna hopping that even more significant gain can be achieved.

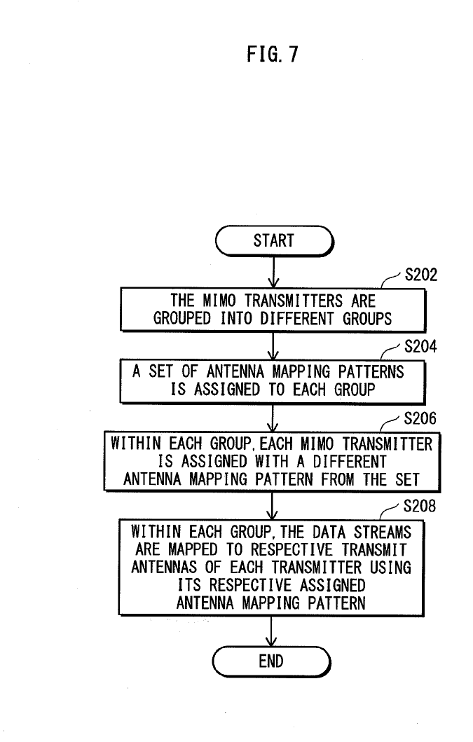

FIG. 7 is a schematic flowchart for illustrating a method for transmitting a plurality of data streams in a Single Frequency Network (SFN) to a User Equipment (UE) using a plurality of Multiple-Input Multiple-Output (MIMO) transmitters in the sixth embodiment. For example, steps S202, S204 and S206 are operated by operator. However, the sixth embodiment is not limited to cases where steps S202, S204 and S206 are operated by operator. That is, steps S202, S204 and S206 may be operated by computer system etc.

At step S202, the MIMO transmitters are grouped into different groups. At step S204, a set of antenna mapping patterns is assigned to each group. Where the respective antenna mapping patterns are based on a spatial correlation of a plurality of data streams in respective transmit antennas of the MIMO transmitter. At step S206 within each groups, each transmitter is assigned with a different antenna mapping pattern from the set. At step S208, within each group, the data streams are mapped to respective transmit antennas of each MIMO transmitter using its respective assigned antenna mapping patterns.

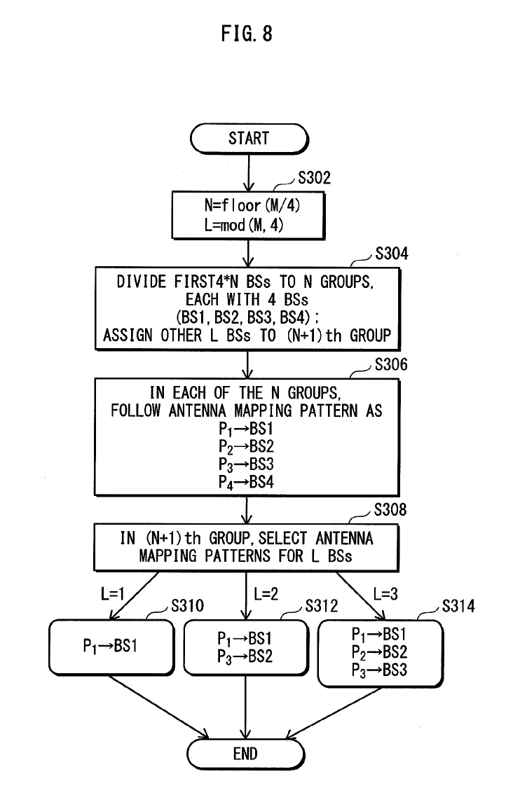

FIG. 8 is a schematic flowchart for illustrating a method for antenna mapping pattern selection in the seventh embodiment. For example, steps S302 to S314 are operated by operator. However, the seventh embodiment is not limited to cases where steps S302 to S314 are operated by operator. That is, steps S302 to S314 may be operated by computer system etc. In the seventh embodiment, each BS comprises four transmit antennas Ant1, Ant2, Ant3, Ant4 and each UE comprises four receive antennas. Using spatial multiplexing, four data streams s₁, s₂, s₃, s₄ are broadcast or multicast to each UE. For convenience of description, four antenna mapping patterns P₁, P₂, P₃, and P₄ are provided for the seventh embodiment, i.e.,
P₁: (s₁→Ant1 s₂→Ant2 s₃→Ant3 s₄→Ant4)
P₂: (s₂→Ant1 s₁→Ant2 s₄→Ant3 s₃→Ant4)
P₃: (s₃→Ant1 s₄→Ant2 s₁→Ant3 s₂→Ant4)
P₄: (s₄→Ant1 s₃→Ant2 s₂→Ant3 s₁→Ant4)

P₁, P₂, P₃, and P₄ are designed based on a spatial correlation of data streams in the respective Ant1, Ant2, Ant3 and Ant4,

In the seventh embodiment, multiple different antenna mapping patterns can employed over M BSs. At step S302, the number of BSs M is divided by 4 to obtain N and L. Thus, N is the division quotient within a round-off error of an integer and L is the modulus after division, i.e., M=4*N+L. Therefore, N and L are both integers and L≦3. At step S304, all the BSs are divided into N+1 groups. Every four BSs among the first 4*N BSs are assigned to one of N groups. The remaining other L BSs are assigned to the (N+1)th group. In other words, the BSs are divided into groups of fours. The reminder of the BSs (i.e. three or less BSs) are grouped into the (N+1)th group.

At step S306, for each of the first N groups, the antenna mapping pattern P₁ is assigned to a first BS (BS1), the antenna mapping pattern P₂ is assigned to a second BS (BS2), the antenna mapping pattern P₃ is assigned to a third BS (BS3), and the antenna mapping pattern P₄ is assigned to a fourth BS (BS4). The BS1, BS2, BS3 and BS4 perform antenna hopping using the assigned antenna mapping patterns P₁, P₂, P₃, and P₄ respectively.

At step S308, antenna mapping patterns are selected for the (N+1)th group based on the value of L.

If L=1, the antenna mapping pattern P₁ among the antenna mapping patterns P₁ to P₄ is selected for one BS1 at step S308, and the selected antenna mapping pattern P₁ is assigned to the BS1 at step S310. The BS1 performs antenna hopping using the assigned antenna mapping pattern P₁. Alternatively, the antenna mapping pattern may also be any one of P₁ to P₄.

If L=2, the antenna mapping patterns P₁, P₃ among the antenna mapping patterns P₁ to P₄ are selected for two BS1 and BS2 at step S308, and the selected antenna mapping patterns P₁ and P₃ are assigned to the BS1 and BS2 respectively at step S312. The BS1 and BS2 perform antenna hopping using the assigned antenna mapping patterns P₁ and P₃ respectively. Alternatively, the antenna mapping patterns may also be P₂ and P₄.

If L=3, the antenna mapping patterns P₁, P₂, P₃ among the antenna mapping patterns P₁ to P₄ are selected for three BS1, BS2 and BS3 at step S308, and the selected antenna mapping patterns P₁, P₂ and P₃ are assigned to the BS1, BS2 and BS3 respectively at step S314. The BS1, BS2 and BS3 perform antenna hopping using the assigned antenna mapping patterns P₁, P₂ and P₃ respectively. Alternatively, the antenna mapping patterns may also be any three selected from P₁ to P₄.

The above described embodiments can be applied generally to telecommunications, and for broadcasting and multicasting from a cellular Single Frequency Network (SFN). The described embodiments can apply to transmitting data from a plurality of Base Stations (BSs) in a cellular communication system. The described embodiments can apply distributed antenna hopping to the BSs to balance experienced spatial correlation among data streams transmitted from different BSs and compensate capacity loss due to spatial correlation. The described embodiments can assign different antenna mapping patterns to each of a plurality of BSs. In each BS, the spatial multiplexing technique may be used to improve the spectral efficiency and multiple data streams may be applied with antenna hopping by being multiplied with one or more permutation matrices, and then transmitted from multiple transmit antennas.

The described embodiments can provide a cellular communication system that includes a plurality of Base Stations (BSs). Each BS may have at least three transmit antennas. Each BS may have a means or module for introducing antenna hopping to multiple data streams. The means for introducing antenna hopping with multiple data streams can comprise multiplying the multiple data streams with a permutation matrix, wherein the permutation matrix used in each BS can be different from each other in order to balance the spatial correlations experienced by each spatial data stream transmitted from the plurality of BS in the cell.

The described embodiments can provide a distributed antenna hopping method that includes the following operations. (1) Selecting different antenna mapping patterns corresponding to different permutation matrices with each of a plurality of Base Stations (BSs). The antenna mapping patterns can be designated to be able to balance average SNRs of all data streams based on transmit spatial correlations. (2) Permuting the multiple data streams with an assigned permutation matrix by multiplying the data streams with the matrix in each BS. (3) Transmitting permuted data streams through multiple transmit antennas from each BS.

Thus, the described embodiments can use Multiple-Input Multiple Output (MIMO) techniques to increase spectral efficiency of a cellular Single Frequency Network (SFN). The described embodiments can provide methods and apparati for applying distributed antenna hopping for spatial multiplexing in multi-cell SFN transmission systems. In the described embodiments, data stream mapping to physical antennas can vary with different BSs based on spatial correlation, to balance the channel spatial correlation experienced by each data stream. The antenna mapping patterns in the described embodiments can be designed for multiple BSs for broadcast or multicast transmissions in a SFN.

It will be appreciated that although the described embodiments relates to four antenna applications, they are not limited as such and can be extended to MIMO systems in which more than three transmit antennas are used. The above-described antenna mapping patterns should be treated as examples resulting from a general method for antenna hopping based on spatial correlation. It will also be appreciated that other modifications and variations of the described antenna mapping patterns are possible.

It will be appreciated by a person skilled in the art that the numerous variations and/or modifications may be made to the present invention as shown in the specific embodiments without departing from the sprit or scope of the invention as broadly described. The present embodiments are, therefore, to be considered in all respects to be illustrative and not restrictive.

What is claimed is:

1. A Multiple-Input Multiple-Output (MIMO) transmitter for transmitting a plurality of data streams in a Single Frequency Network (SFN) to a receiver, the MIMO transmitter comprising:
a plurality of transmit antennas; and
an antenna hopping module for performing an antenna hopping that maps the data streams to the respective transmit antennas based on a spatial correlation of the data streams in the respective transmit antennas.

2. The MIMO transmitter as claimed in claim 1, wherein the antenna hopping is performed using a permutation matrix formed based on the spatial correlation of the data streams in the respective transmit antennas.

3. The MIMO transmitter as claimed in claim 1, wherein the antenna hopping module performs the antenna hopping such that Signal-to-Noise Ratios of the data streams at the receiver are balanced as a result of permutations of the data streams in respective MIMO transmitters of the SFN.

4. The MIMO transmitter as claimed in claim 3, wherein the Signal-to-Noise Ratios of the data streams are balanced to approach identical values.

5. The MIMO transmitter as claimed in claim 1, wherein the antenna hopping module performs the antenna hopping that maps the data streams in a varying antenna mapping pattern for different transmission time slots.

6. The MIMO transmitter as claimed in claim 1, further comprising a power allocation module for performing a power allocation that adjusts power allocation to the data streams.

7. The MIMO transmitter as claimed in claim 6, wherein the power allocation is performed using a power allocation matrix.

8. The MIMO transmitter as claimed in claim 1, wherein the data streams and corresponding data streams being transmitted by other MIMO transmitters in the SFN comprise same data contents.

9. The MIMO transmitter as claimed in claim 1, wherein the number of transmit antennas is more than three.

10. The MIMO transmitter as claimed in claim 1, wherein the MIMO transmitter is a Base Station.

11. A method for transmitting a plurality of data streams in a Single Frequency Network (SFN) to a receiver, the method comprising:
mapping the data streams to respective transmit antennas of a Multiple-Input Multiple-Output (MIMO) transmitter based on a spatial correlation of the data streams in the respective transmit antennas.

12. The method as claimed in claim 11, wherein a plurality of Multiple-Input Multiple-Output (MIMO) transmitters is used, the method comprising:
grouping the MIMO transmitters into different groups;
assigning a set of antenna mapping patterns to each group;
wherein within each group,
assigning each MIMO transmitter with a different antenna mapping pattern from the set;
mapping the data streams to respective transmit antennas of each MIMO transmitter using its respective assigned antenna mapping pattern; and
wherein the antenna mapping pattern is based on a spatial correlation of the data streams in the respective transmit antennas.

13. The method as claimed in claim 12, wherein said grouping the MIMO transmitters into different groups comprises grouping the MIMO transmitters in groups of four into N groups and grouping the remainder of the MIMO transmitters into a (N+1)th group; the method further comprising:
for each N group,
assigning a first antenna mapping pattern to a first MIMO transmitter;
assigning a second antenna mapping pattern to a second MIMO transmitter;
assigning a third antenna mapping pattern to a third MIMO transmitter;
assigning a fourth antenna mapping pattern to a fourth MIMO transmitter;
for (N+1)th group,
if the number of MIMO transmitters is one in the (N+1)th group,
assigning one of the first, second, third and fourth antenna mapping patterns to that one MIMO transmitter;
if the number of MIMO transmitters is two in the (N+1)th group,
assigning different antenna mapping patterns to the MIMO transmitters by selecting one set from a set comprising the first and third antenna mapping patterns and a set comprising the second and fourth antenna mapping patterns;
if the number of MIMO transmitters is three in the (N+1)th group,
assigning different antenna mapping patterns to the MIMO transmitters by selecting one set from a set comprising the first, second and third antenna mapping patterns, a set comprising the first, third and fourth antenna mapping patterns, a set comprising the first, second and fourth antenna mapping patterns and a set comprising the second, third and fourth antenna mapping patterns.

14. A Multiple-Input Multiple-Output (MIMO) communication system for transmitting a plurality of data streams in a Single Frequency Network (SFN) to a receiver, the MIMO communication system comprising:
two or more MIMO transmitters, each MIMO transmitter for transmitting the plurality of data streams;
wherein each MIMO transmitter comprising:
a plurality of transmit antennas, and
an antenna hopping module for antenna hopping that maps the data streams to the respective transmit antennas based on a spatial correlation of the data streams in the respective transmit antennas.
